(19) United States
(12) Patent Application Publication
(10) Pub. No.: US 2025/0389530 A1
(43) Pub. Date: Dec. 25, 2025

(54) OPTICAL CRITICAL DIMENSIONS (OCD) METROLOGY FOR THICK STACKS

(71) Applicant: NOVA LTD., Rehovot (IL)

(72) Inventors: Yishai Schreiber, Rehovot (IL); Amir Shayari, Rehovot (IL); Ido Adam, Rehovot (IL); Smadar Ferber, Rehovot (IL); Oded COHEN, Rehovot (IL); Haim Prigozin, Rehovot (IL); Amir Sagiv, Rehovot (IL); Gilad Barak, Rehovot (IL)

(73) Assignee: NOVA LTD., Rehovot (IL)

(21) Appl. No.: 18/879,248

(22) PCT Filed: Jun. 28, 2023
(86) PCT No.: PCT/IB2023/056649

§ 371 Date: Dec. 27, 2024

Related U.S. Application Data
(60) Provisional application No. 63/356,531, filed on Jun. 29, 2022.

(51) Int. Cl. G01B 11/06; G01N 21/55

(52) U.S. Cl. CPC G01B 11/0675; G01N 21/55

(57) ABSTRACT

A method for evaluating a thick transparent layer, the method includes (i) generating information about relationships between measurements of a spectrometer of an interferometer and optical path difference (OPD) values of the interferometer; wherein the generating of the information comprises illuminating the thick transparent layer by the interferometer: (ii) determining one or more thick transparent layer reflection parameters, based on the information about the relationship; and (iii) determining one or more structural properties of the thick transparent layer based on the one or more thick transparent layer reflection parameters.

### CROSS REFERENCE

This application claims priority from U.S. provisional patent Ser. No. 63/356,531 filing date Jun. 29, 2022 which is incorporated herein in its entirety.

### BACKGROUND

Scatterometry methods such as Spectral Reflectometry (SR), Spectral Ellipsometry (SE) and Spectral Interferometry (SI) are extensively used in semiconductor process control. These techniques provide valuable information on the measured layers and nanostructures, characterizing their dimensions and material properties.

All these methods incur a critical challenge when measuring thick, transparent structures: the reflected spectrum from such structures typically includes extremely fast oscillations, meaning—reflection is significantly changed for extremely small wavelength differences.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1B illustrate examples of a spectral interferometry system;

FIG. 2 illustrates a method according to an embodiment of the invention; and

FIG. 3 illustrates various sinusoidal relationships.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using optical components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a non-transitory computer readable medium that stores instructions that once executed by a computer result in the execution of the method.

Any reference in the specification to a non-transitory computer readable medium should be applied mutatis mutandis to a method that may be executed by a computer that reads the instructions stored in the non-transitory computer readable medium.

In order to resolve spectral features a thick transparent layer, an extremely high spectral resolution is required for the measurement apparatus (e.g. spectrometer), which is technically challenging, has various negative effects on other measurement attributes (SNR, cost, complexity) and for very thick stacks—simply not feasible.

In such situations, the measured spectrum is ‘smeared’ with spectral features unresolved by the measurement. Such situation leads to loss of sensitivity and applicability of the metrology solution. Furthermore, simulating this expected spectrum under such conditions—a key ingredient in many OCD interpretation schemes—is extremely computationally expensive in such situations, requiring the reflection simulation from very high number of wavelengths and often a dense set of angles of incidence.

As stated, increased measurement spectral resolution can help resolve the fast spectral oscillations, at the expense of performance, cost and complexity. Moreover, such solutions are not scalable—as semiconductor applications become thicker, high-end spectrometers cannot keep up with the required spectral resolution.

Another possible approach involves using longer wavelengths, i.e. IR and MIR (Infra-Red and Mid-Infra-Red). Very roughly, the frequency of the spectral oscillations is proportional to 1/λ (with λ the wavelength), leading to slower oscillations at longer wavelengths. Such mitigation has multiple negative aspects—in terms of lost sensitivity (UV and Vis wavelength ranges hold various unique sensitivities to attributes of the measured structure) as well as system complexity, measurement times (due to lower brightness light sources and lower efficiency detectors) and measurement spot size (due to diffraction of the longer wavelengths).

A straightforward solution to the spectral resolution challenge is given by monochromator-based solutions, where a scanning element measures the scattered light at a specific wavelength at any given instant. Extremely high spectral resolutions are attainable in such approaches, but at the expense of very long measurement times—commonly unsuitable for process control during High-Volume Manufacturing and high-throughput metrology.

Another alternative for increased spectral resolution is provided by Fourier-based methods. In such methods an integral over a broad spectral range is measured, but using a scanning element (typically a mirror) different measurement instances capture different weighted-sums of the signal. Methods in this category are Fourier-Transform IR (FTIR) and White Light Interferometry (WLI). Typically, the eventual spectral resolution is proportional to the range across which the scanning element is swept, allowing very high spectral resolutions. However, as before, high resolutions come at the direct expense of measurement time.

This disclosure describes a new measurement sequence and supporting algorithmic approach, removing the concern of fast spectral oscillations described above. The method may be applied using various system and/or different implementations of Spectral Interferometry. An example of a system configured to perform spectral interferometry is illustrated in U.S. Pat. No. 10,161,885 which is incorporated herein by reference—after being configured (for example programmed to) execute the methods illustrated in this disclosure. Other systems may be provided to implements the methods illustrated in this disclosure.

There is a provided a spectral interference (SI) system for evaluating a thick transparent layer, the SI system includes (i) an interferometer is configured to illuminate the thick transparent layer and to provide measurements of a spectrometer of the interferometer; and (ii) an processing circuit that is configured to: generate information about relationships between the measurements of the spectrometer and optical path difference (OPD) values of the interferometer that are associated with the measurement; (b) determine one or more thick transparent layer reflection parameters, based on the information about the relationship; and (c) determine one or more structural properties of the thick transparent layer based on the one or more thick transparent layer reflection parameters.

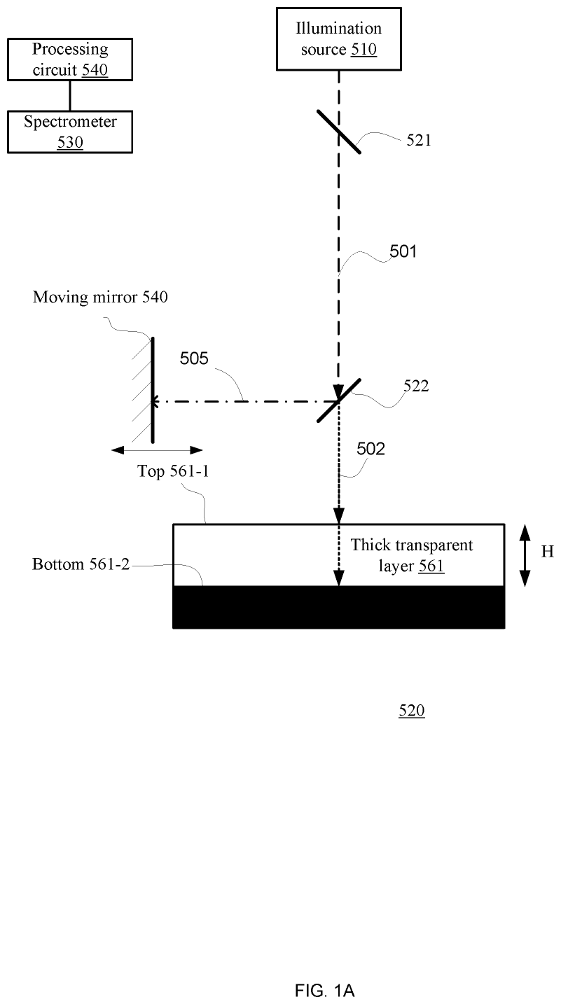

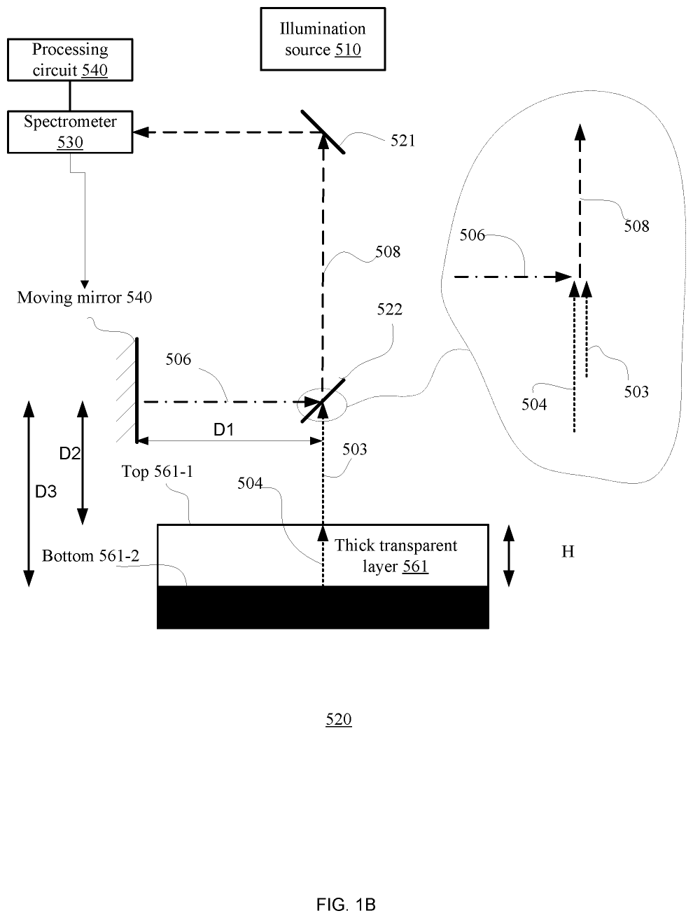

FIGS. 1A and 1B illustrate an example of an SI measurement of a thick layer.

The SI measurement is performed by a SI system that includes interferometer 520. The interferometer 520 may include processing circuit 540. Alternatively, the processing circuit 540 may be included in the SI system without belonging to the interferometer. The processing circuit 540 may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

An illumination source 510 directs light towards an interferometer 520. The light 501 propagates through a first beam splitter 521 of the interferometer. The light propagates towards a second beam splitter 522 of the interferometer and is split to two parts.

A first part 502 propagates to the sample, and is reflected (once or multiple times) from the sample (to provide at least one reflected beam) and then reaches the second beam splitter.

When a thick layer is illuminated than the top surface of the thick layer reflects light to provide a first reflected beam 503, and the bottom surface of the thick layer reflects light to provide a second reflected beam 504.

A second part 505 is directed to a movable reference mirror 540, and is reflected from the movable mirror (to provide a reference reflected beam 506) and reaches the second beam splitter. The first reflected beam, the second reflected beam and the reference beam form an interference pattern 508 that propagates to the first beam splitter which directs the interference pattern to a spectrometer 530 (of the interferometer 520) that provides spectrometer measurements such as spectrums. The spectrometer may be a one-dimensional or a multi-dimensional spectrometer.

We can describe the measured signal in terms of the interference between light reflected from the sample and the reference mirror. A simplified description of the collected interference signal at wavelength A can be expressed as:

$$I ( λ , z ) = {\vert {E}_{m} ( λ ) {e}^{i \frac{2 π}{λ} z} + {E}_{w} ( λ ) \vert}^{2}$$

Here, Eₘ(λ) is the field reflectivity of the mirror and E_{w}(λ) the field reflectivity of the sample. The reflectivity of the sample, parts of it, or of constituents of the measuring system, are all assumed to be functions of λ, and the explicit dependence of them, and of their amplitudes and phases, will be henceforth omitted. z represents the path-length difference between the two light paths—from the second beam splitter to the reference mirror (path ‘A’ in the sketch) and to the sample top and/or bottom (paths ‘B’ and C).

Clearly, this description is grossly simplified; it does not account for the different transmissions of the two light paths, the overall system transmission, light source intensity, detector collection efficiency etc. Here and in the discussion below all elements not important for the discussed invention are omitted for simplification (and can be accounted for by standard methods and calibrations).

To clearly describe the invention, we can define several technical terms.

Optical Path Difference (OPD) matching: the Optical Path Difference is the difference in path length between two light paths. The optical path length of each path is the product of the geometric length and the refractive index of the material through which the light is propagating. In interferometric measurements, the OPD plays an important role in determining the character of the measured signal. OPD matching is the practice of tuning a system to a specific value, or range of values, of the OPD. The OPD matching may have a crucial effect on the measurement, e.g., if the OPD is too large the coherence may be lost, as explained below.

Coherence: two electromagnetic waves are said to be coherent if they are correlated during the measurement time and hence produce an interference pattern in time or in space. The intensity of the interference of two fields E₁e^{i[ω}^{₁}^{t+ϕ}^{₁}^{]} and E₂e^{i[ω}^{₂}^{t+ϕ}^{₂}^{]} contains the contribution of the intensities of the two fields |E₁|²+|E₂|² and the interference term 2Re [symbol] E*₁E₂e^{i[(ω}^{₂}^{-ω}^{₁}^{)t+ϕ}^{₂}^{-ϕ}^{₁}^{]} [symbol] , where [symbol] ⋅ [symbol] denotes time-averaging. If the time dependance of the phases ϕ₁ and ϕ₂ is completely uncorrelated, the average will vanish. Similarly, if ω₁ and ω₂ are different, the interference term will be suppressed. The coherence γ is defined as the ratio between the measured interference term (which can be measured, for example, by moving one of the mirrors in an interferometer (e.g. Michaelson) and measuring the amplitude of the resulting oscillations, as described in the above noticed U.S. Pat. No. 10,161,885), and the interference expected for fully coherent fields.

One source of decoherence is the finite spectral resolution of the spectrometer. Consider a light wave leaving the light source and being split into two beams which travel optical paths L₁ and L₂, respectively, which are then recombined in the spectrometer. If the spectrometer's effective pixel (which is determined by e.g., pixel width, point-spread-function (PSF) of the spectrometer, finite spot size, etc.) collects fields between wave-numbers k and k+Δk, the measured interference term is ∫ₖ^{k+Δk} dk E*₁(k)E₂(k)^{i[k(L}^{₂}^{-L}^{₂}^{)+ϕ}^{₂}^{-ϕ}^{₁}^{]} for simplicity we assume the integration time is long enough so different wavelengths are completely incoherent and do not interfere, and that E_{1,2} and ϕ_{1,2} change slowly with k.

However, these assumptions are not essential for the idea. If L₂ and L₁ differ by too much, the integrand will be highly oscillatory and the integral will be highly suppressed, so the interference term will be small and the coherence γ will be low. For the coherence to be high, one should require Δk(L₂−L₁)<<2π, so the coherence length—the OPD above which the interference is significantly suppressed—is inversely proportional to the spectral resolution Δk.

Hence, in order to have reasonably high coherence, the OPD between the two beams, must be small enough, which is termed OPD matching. In a thick enough measured sample, it is impossible to have both top reflection and second reflection (first reflected beam and second reflected beam) to be OPD-matched with the beam passing in the other arm (the reference beam) of the interferometer. Thus, at least one of them will suffer significant decoherence and hence its phase relative to the reference beam cannot be measured, and in fact is ill-defined.

Referring to a sample that includes a thick transparent layer that includes two reflecting interfaces. The idea can be applied to any thick sample.

The reflection from a sample with two reflecting interfaces can be approximated as

$${E}_{w} ( λ ) = {E}_{top} ( λ ) + {E}_{bottom} ( λ ) {e}^{i \frac{2 π}{λ} 2 Hn}$$

Where Eₜₒₚ=|Eₜₒₚ|e^{iϕ}^{ₜₒₚ} is the field-reflectivity from the top interface, E_{bottom}=|E_{bottom}|e^{iϕ}^{_{bottom}} is the field-reflectivity from the bottom, H is the geometric difference between the interfaces, and n is the refractive index of the layer in between. The exponential factor

$${e}^{i \frac{2 π}{λ} 2 Hn}$$

represents the phase the light accumulates as it completes a full round-trip through the transparent sample.

An ideal reflected signal would be

$${\vert {E}_{w} \vert}^{2} = {\vert {E}_{top} \vert}^{2} + {\vert {E}_{bottom} \vert}^{2} + 2 \vert {E}_{top} {E}_{bottom} \vert cos ( {ϕ}_{top} - {ϕ}_{bottom} - \frac{2 π}{λ} 2 Hn ) .$$

However, the interference between the top and the bottom is in general not fully coherent. This is due to several physical causes, e.g., finite spectrometer resolution etc., as explained above. Under such conditions, the measured signal can be approximated by

$${R}_{measured} = {\vert {E}_{top} \vert}^{2} + + {\vert {E}_{bottom} \vert}^{2} + 2 \vert {E}_{top} {E}_{bottom} \vert {e}^{- 2 {σ}_{k}^{2} {H}^{2} {n}^{2}} cos ( {ϕ}_{top} - {ϕ}_{bottom} - \frac{2 π}{λ} 2 Hn )$$

where σₖ is an effective parameter describing the decoherence mechanisms (e.g., spectrometer resolution).

Under the same assumptions, an idealized interferometric signal would be

$$I = {\vert {E}_{m} {e}^{i \frac{2 π}{λ} z} + {E}_{top} + {E}_{bottom} {e}^{i \frac{2 π}{λ} 2 Hn} \vert}^{2}$$

Which, after taking decoherence into account, will result in the measured signal

$${I}_{measured} = {\vert {E}_{top} \vert}^{2} + {\vert {E}_{bottom} \vert}^{2} + {\vert {E}_{m} \vert}^{2} + + 2 \vert {E}_{top} {E}_{bottom} \vert {e}^{- 2 {σ}_{k}^{2} {H}^{2} {n}^{2}} cos ( {ϕ}_{top} - {ϕ}_{bottom} - \frac{2 π}{λ} 2 Hn ) + + 2 \vert {E}_{top} {E}_{m} \vert {e}^{- \frac{{σ}_{k}^{2} {z}^{2}}{2}} cos ( {ϕ}_{top} - {ϕ}_{m} - \frac{2 π}{λ} z ) + + 2 \vert {E}_{bottom} {E}_{m} \vert {e}^{- \frac{{{σ}_{k}^{2} ( 2 Hn - z )}^{2}}{2}} cos ( {ϕ}_{bottom} - {ϕ}_{m} - \frac{2 π}{λ} ( z - 2 Hn ) ) .$$

Please note that while the decoherence factor of the first interference term (EₜₒₚE_{bottom}) depends only on the sample itself, the decoherence of the other terms (EₜₒₚEₘ and E_{bottom} Eₘ) depends on the OPD (through z). Thus, the OPD matching has an important role in determining which terms will be coherent and which will suffer more significantly from decoherence. If the matching will be to the top surface, namely |z|<<σₖ⁻¹, the interference of the top and the mirror will be coherent. If, on the other hand, the matching will be to the bottom, namely |2Hn−z|<<σₖ⁻¹, the bottom will coherently interfere with the mirror. (If Hn<<σₖ⁻¹ both conditions can be fulfilled.)

Without loss of generality, let us describe the invention for the case of OPD matching to the top surface. The same ideas, with required modifications, apply to the coherent interference with any reflecting surface.

While for Hn>σₖ⁻¹ the total measured signal is not coherent, one can extract the coherent part of the signal. Consider S=I_{measured}−|Eₘ|²−R_{measured}. This entity is accessible through direct measurements of the mirror and the sample. From the above we get

$$S = 2 \vert {E}_{top} {E}_{m} \vert {e}^{- \frac{{σ}_{k}^{2} {z}^{2}}{2}} cos ( {ϕ}_{top} - {ϕ}_{m} - \frac{2 π}{λ} z ) + \text{} + 2 \vert {E}_{bottom} {E}_{m} \vert {e}^{- \frac{{{σ}_{k}^{2} ( 2 Hn - z )}^{2}}{2}} cos ( {ϕ}_{bottom} - {ϕ}_{m} - \frac{2 π}{λ} ( z - 2 Hn ) )$$

Let us emphasize that these are the only terms that depend on z, and therefore they are the only ones that contribute to the phase extraction in SI measurements.

One can write S as a coherent interference of the mirror with a field

$${E}_{c} = \vert {E}_{top} \vert {e}^{- \frac{{σ}_{k}^{2} {z}^{2}}{2}} {e}^{i {ϕ}_{t o p}} + \vert {E}_{bottom} \vert {e}^{- \frac{{{σ}_{k}^{2} ( 2 Hn - z )}^{2}}{2}} {e}^{i ( {ϕ}_{bottom} + \frac{2 π}{λ} 2 Hn )} .$$

For simplicity, consider the case σₖ²z²<<1. The intensity related to E_{c} is then

$${\vert {E}_{c} \vert}^{2} = {\vert {E}_{top} \vert}^{2} + + {\vert {E}_{bottom} \vert}^{2} {e}^{- 2 {{σ}_{k}^{2} ( Hn )}^{2}} + 2 \vert {E}_{top} {E}_{bottom} \vert {e}^{- 2 {{σ}_{k}^{2} ( Hn )}^{2}} cos ( {ϕ}_{top} - {ϕ}_{bottom} - \frac{2 π}{λ} 2 Hn )$$

Note the difference between |E_{c}|² and R_{measured}−in |E_{c}|² the reflection from the interface that is not OPD-matched to the mirror is attenuated, and only the coherent part of the reflection remains.

The solution may use |E_{c}|, the coherent part of the reflection, as the amplitude of the complex SI signal, instead of \sqrt{R_{measured}}.

In SI measurements, the field-reflectivity is extracted from a set of measurements

$$I ( λ , {z}_{i} ) = {\vert {E}_{m} {e}^{i \frac{2 π}{λ} {z}_{i}} + {E}_{w} \vert}^{2} .$$

As discussed above, the measured signal undergoes several decoherence processes. Thus, the interference term S=I_{measured}−|Eₘ|²−R_{measured} is written as

$$2 \vert {E}_{m} {E}_{w} \vert γcos ( {ϕ}_{w} - {ϕ}_{m} - \frac{2 π}{λ} {z}_{i} ) ,$$

where γ(λ) is a factor describing all decoherence effects. From a set of such measurements, with prior knowledge of |Eₘ|² and ϕₘ, the phase ϕ_{w} is extracted. However, as explained above, the phase Ow is related to the field E_{c} rather than to E_{w}. But, by comparing the above analysis to the expression for S, E_{c} is nothing but γE_{w}. This is true for the decoherence causes described above. However, there may be additional decoherence mechanisms. Let us denote the decoherence due to imperfections of the apparatus as γ_{sys}. Then

$$S = 2 \vert {E}_{m} \vert {γ}_{s γ s} \vert {E}_{c} \vert cos ( {ϕ}_{w} - {ϕ}_{m} - \frac{2 π}{λ} {z}_{i} ) .$$

As long as γ_{sys} is constant and does not depend on the measured sample, it can be calibrated out.

So, taking the pre-factor of the cosine and dividing by 2|Eₘ|γ_{sys}, the coherent amplitude is obtained.

There may be additional decoherence factors, which cannot be simply calibrated out. One of these is the effect of vibrations on the measurement. If the mirror or the sample vibrate during the measurement, the OPD (z in the equations above) is not well defined. To leading order, the effect on the spectrum can be written as a multiplicative factor

$$( 1 - \frac{2 π {m}^{2}}{{λ}^{2}} ) ,$$

where m is an unknown coefficient that characterizes the amplitude of vibrations in a specific measurement. Since m varies between measurements, comparison or any other processing of the interferometric signal can be done only after accounting for this factor. This can be done in several ways. One approach is to fit m by optimizing some objective function (e.g., maximizing signal explained by the model) or fulfilling other known requirements, for example, matching between two spectra. Another option is to remove from all spectra every component that has the functional form

$$\frac{2 π}{λ} S .$$

One way of doing this is by projecting the spectrum on the orthogonal complement of these components. Similar treatment can be applied to other decoherence factors.

The implications of measuring the coherent field-reflectivity are vast. The so-called VTS algorithm (Disclosed in PCT Patent Application No. PCT/IB2022/050774) relies on SI measurement results, which are composed of an amplitude and a phase. For thick stacks, the effects of decoherence become prominent, and it is crucial that the VTS algorithm will be applied on a coherent signal. With this invention the spectral range of applicability becomes essentially unlimited. The use of shorter wavelengths for VTS is translated into improved vertical resolution. In addition, it reveals physical information that exists only in these ranges.

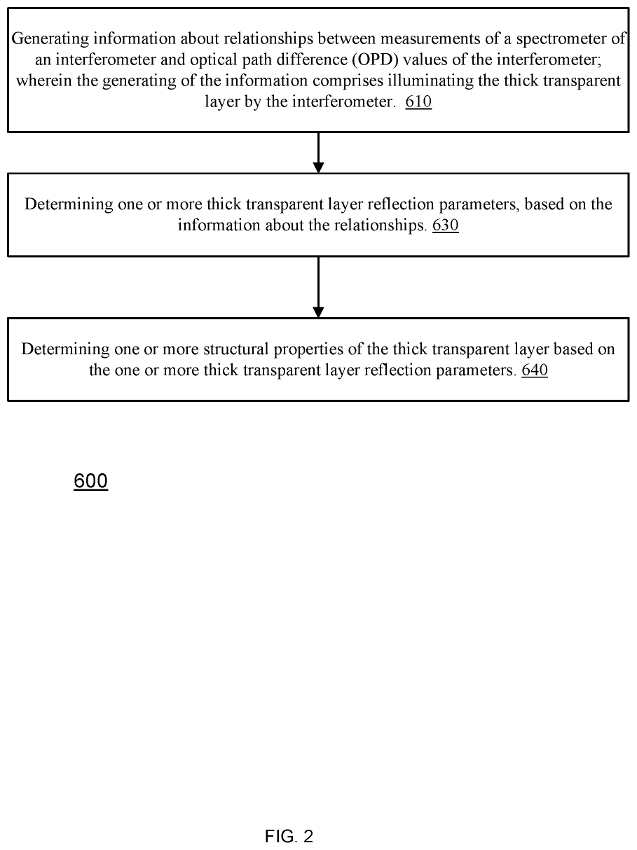

FIG. 2 illustrates an example of method 600 for evaluating a thick transparent layer.

Method 600 may include step 610 of generating information about relationships between measurements of a spectrometer of an interferometer and optical path difference (OPD) values of the interferometer. The generating of the information includes illuminating the thick transparent layer by the interferometer.

Assuming that the signal that is measured by the spectrometer is:

$${I}_{measured} = {\vert {E}_{top} \vert}^{2} + {\vert {E}_{bottom} \vert}^{2} + {\vert {E}_{m} \vert}^{2} + 2 \vert {E}_{top} {E}_{bottom} \vert {e}^{- 2 {σ}_{k}^{2} {H}^{2} {n}^{2}} cos ( {ϕ}_{top} - {ϕ}_{bottom} - \frac{2 π}{λ} 2 H n ) + 2 \vert {E}_{top} {E}_{m} \vert {e}^{- \frac{{σ}_{k}^{2} {z}^{2}}{2}} cos ( {ϕ}_{top} - {ϕ}_{m} - \frac{2 π}{λ} z ) + 2 \vert {E}_{bottom} {E}_{m} \vert {e}^{- \frac{{{σ}_{k}^{2} ( 2 H n - z )}^{2}}{2}} cos ( {ϕ}_{bottom} - {ϕ}_{m} - \frac{2 π}{λ} ( z - 2 Hn ) ) .$$

The values of

$${I}_{incoherent} = {\vert {E}_{top} \vert}^{2} + {\vert {E}_{bottom} \vert}^{2} + {\vert {E}_{m} \vert}^{2} + 2 \vert {E}_{top} {E}_{bottom} \vert {e}^{- 2 {σ}_{k}^{2} {H}^{2} {n}^{2}} cos ( {ϕ}_{top} - {ϕ}_{bottom} - \frac{2 π}{λ} 2 Hn )$$

can be found in several ways.

One way is to obtain a non-interferometric measurement, by which the interferometer mirror is tilted and reflections from it are not returned into the light path. As explained in [0038], such a measurement provides the value of

$${\vert {E}_{top} \vert}^{2} + {\vert {E}_{bottom} \vert}^{2} + 2 \vert {E}_{top} {E}_{bottom} \vert cos ( {ϕ}_{top} - {ϕ}_{bottom} - \frac{2 π}{λ} 2 H n ) .$$

A separate measurement of the mirror reflectivity |Eₘ|² can be obtained with the sample removed. This second measurement can be taken once (or at least infrequently), as the mirror reflectivity does not depend on the measured sample.

Another way to obtain I_{incoherent} is by isolating the part which does not vary with mirror position from the interferometric measurements. The measured signal can be written as

$${I}_{measured} ( λ ) = {I}_{incoherent} ( λ ) + A ( λ ) \cdot cos ( ϕ ( λ ) - \frac{2 π}{λ} z ) .$$

Using few (at least 3) measurements at different values of the mirror position z it is possible to separately find the I_{incoherent}(λ), A(λ) and ϕ(λ).

The value of

$${e}^{- \frac{{σ}_{k}^{2} {z}^{2}}{2}}$$

is about one when the moving mirror is spaced apart from the second beam splitter by a distance (D1) that substantially equals the distance (D2) between the top surface of the thick transparent layer and the second beam splitter.

In this case the value of

$$2 \vert {E}_{top} {E}_{m} \vert {e}^{- \frac{{σ}_{k}^{2} {z}^{2}}{2}} cos ( {ϕ}_{top} - {ϕ}_{m} - \frac{2 π}{λ} z )$$

can be approximated by

$$2 \vert {E}_{top} {E}_{m} \vert cos ( {ϕ}_{top} - {ϕ}_{m} - \frac{2 π}{λ} z ) .$$

The values of Eₘ, λ and z are known. By slightly changing (for example by tens till hundreds of nanometers) the value of z (while maintaining z to be substantially equal to the distance between the second beam splitter and the top surface)—there will be a sinusoidal relationship between the intensity of a frequency component of the spectrum detected by the spectrometer and the values of z. The difference between the maximum value of the first frequency component and a minimal value of the first frequency component will provide the value of Eₜₒₚ−as 2*Eₜₒₚ*Eₘ equals that difference.

The value of

$${e}^{- \frac{{{σ}_{k}^{2} ( 2 Hn - z )}^{2}}{2}}$$

is about one when the moving mirror is spaced apart from the second beam splitter by a distance (D1) that substantially equals the distance (D3) between the bottom surface of the thick transparent layer and the second beam splitter.

In this case the value of

$$2 \vert {E}_{bottom} {E}_{m} \vert {e}^{- \frac{{{σ}_{k}^{2} ( 2 Hn - z )}^{2}}{2}} cos ( {ϕ}_{bottom} - {ϕ}_{m} - \frac{2 π}{λ} ( z - 2 Hn ) )$$

can be approximated by

$$2 \vert {E}_{bottom} {E}_{m} \vert cos ( {ϕ}_{bottom} - {ϕ}_{m} - \frac{2 π}{λ} ( z - 2 Hn ) ) .$$

The values of Em, λ and z are known. By slightly changing (for example by tens till hundreds of nanometers) the value of z (while maintaining z to be substantially equal to the distance between the second beam splitter and the bottom surface)—there will be a sinusoidal relationship between the intensity of a frequency component of the spectrum detected by the spectrometer and the values of z. The difference between the maximum value of the first frequency component and a minimal value of the first frequency component will provide the value of E_{bottom}−as 2*E_{bottom}*Eₘ equals that difference.

Step 610 may be followed by step 630 of determining one or more thick transparent layer reflection parameters, based on the information about the relationship.

The thick transparent layer reflection parameters may include a field reflectivity of a top of the transparent thick layer and/or the field reflectivity of a bottom of the transparent thick layer.

The spectrometer measurements also provide phase information. The one or more thick transparent layer reflection parameters may also include the relationship between phase changes of any of field reflectivity and frequency changes.

Step 630 may be followed by step 640 of determining one or more structural properties of the thick transparent layer based on the one or more thick transparent layer reflection parameters.

Step 640 may include applying a mapping between the one or more thick transparent layer reflection parameters and the one or more structural properties.

Step 640 may include a modal based analysis that may include attempting to find a matching model that exhibits the same (or similar enough) one or more structural properties.

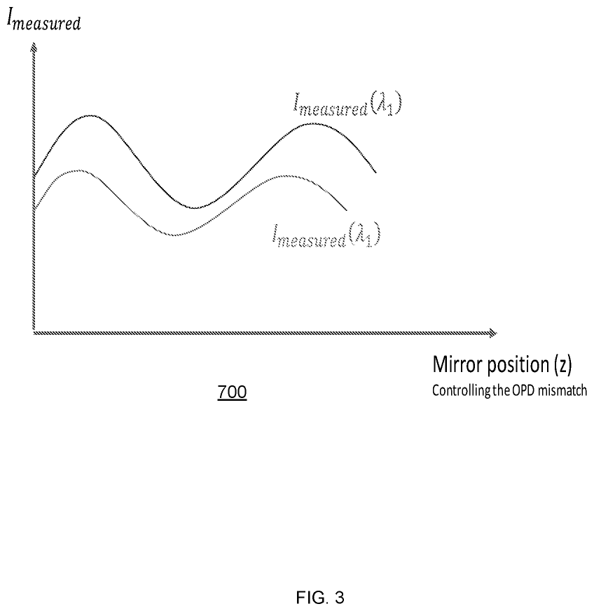

FIG. 3 illustrates an example of sinusoidal relationships reflected by two different frequency components of the spectrometer measurement.

According to an embodiment, there may be provided a method executable by a processing circuit that may not belong to the SI system.

The method may include (a) obtaining information about relationships between measurements of a spectrometer and optical path difference (OPD) values of an interferometer, the interferometer is in optical communication with the spectrometer; wherein the measurements of the spectrum are generated by illuminating the thick transparent layer by the interferometer; (b) determining one or more thick transparent layer reflection parameters, based on the information about the relationship; and (c) determining one or more structural properties of the thick transparent layer based on the one or more thick transparent layer reflection parameters.

An alternative approach, which is included in this invention, is extracting the coherent reflectivity from the interferometric measurements after applying a low-pass filter on the interferometric signal. This approach is based on the fact that for thick stacks there is typically a frequency-separation, namely that the reflection from the top surface and the bottom surface are well-separated in frequency space. Thus, for a signal of the form

$${I}_{measured} = {\vert {E}_{top} \vert}^{2} + {\vert {E}_{bottom} \vert}^{2} + {\vert {E}_{m} \vert}^{2} ++ 2 \vert {E}_{top} {E}_{bottom} \vert {e}^{- 2 {σ}_{k}^{2} {H}^{2} {n}^{2}} cos ( {ϕ}_{top} - {ϕ}_{bottom} - \frac{2 π}{λ} 2 Hn ) ++ 2 \vert {E}_{top} {E}_{m} \vert {e}^{- \frac{{σ}_{k}^{2} {z}^{2}}{2}} cos ( {ϕ}_{top} - {ϕ}_{m} - \frac{2 π}{λ} z ) ++ 2 \vert {E}_{bottom} {E}_{m} \vert {e}^{- \frac{{{σ}_{k}^{2} ( 2 Hn - z )}^{2}}{2}} cos ( {ϕ}_{bottom} - {ϕ}_{m} - \frac{2 π}{λ} ( z - 2 Hn ) ) ,$$

The application of a low pass filter will remove the term related to interference of the top with the bottom, and the term related to the surface which is not OPD-matched—the terms that suffer decoherence. However, terms that do not include interference, and the term describing interference with an OPD-matched surface, will remain. Therefore, from such a filtered signal it is possible to extract a coherent field-reflectivity, which will be associated to the surface that is OPD-matched to the mirror.

The suggested solution enables the use of the entire spectral range (including shorter wavelengths), thus improving vertical resolution, and exploiting the information encoded in these wavelengths, without requiring any new hardware, but rather a simple software implementation.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A spectral interference (SI) system for evaluating a thick transparent layer, the SI system comprising:
an interferometer is configured to illuminate the thick transparent layer and to provide measurements of a spectrometer of the interferometer; and
an processing circuit that is configured to:
(a) generate information about relationships between the measurements of the spectrometer and optical path difference (OPD) values of the interferometer that are associated with the measurement
(b) determine one or more thick transparent layer reflection parameters, based on the information about the relationship; and
(c) determine one or more structural properties of the thick transparent layer based on the one or more thick transparent layer reflection parameters.

2. The SI system according to claim 1, wherein the measurements of the spectrometer comprise top measurements and bottom measurements;
wherein the top measurements are obtained, by the SI system, while changing the OPD values while maintaining OPD matching in relation to a top of the thick transparent layer, and
wherein the bottom measurements are obtained, by the SI system, while changing the OPD values while maintaining OPD matching in relation to a bottom of the thick transparent layer.

3. The SI system according to claim 2, wherein the SI system is configured to change the OPD values while maintaining OPD matching by changing the OPD values by up to tens of nanometers.

4. The SI system according to claim 2, wherein a relationship between a measurement of the spectrometer and the OPD values of the measurement comprises a first sinusoidal relationship between the OPD values of the measurement and a first frequency component of the measurement.

5. The SI system according to claim 4, wherein the information about the relationship comprises a difference between a maximum value of the first frequency component and a minimal value of the first frequency component.

6. The SI system according to claim 5, wherein the processing circuit is configured to determine the one or more transparent layer reflection parameters by determining a field reflectivity of a top or a bottom of the transparent layer.

7. A non-transitory computer readable medium for evaluating a thick transparent layer, the non-transitory computer readable medium stores instructions that once executed by a processing circuit causes the processing circuit to:
generating information about relationships between measurements of a spectrometer of an interferometer and optical path difference (OPD) values of the interferometer; wherein the generating of the information comprises illuminating the thick transparent layer by the interferometer;
obtain information about relationships between measurements of a spectrometer and optical path difference (OPD) values of an interferometer, the interferometer is in optical communication with the spectrometer; wherein the measurements of the spectrum are generated by illuminating the thick transparent layer by the interferometer;
determine one or more thick transparent layer reflection parameters, based on the information about the relationship; and
determine one or more structural properties of the thick transparent layer based on the one or more thick transparent layer reflection parameters.

8. The non-transitory computer readable medium according to claim 7, wherein the measurements of the spectrometer comprise top measurements and bottom measurements;
wherein the top measurements are obtained while changing the OPD values while maintaining OPD matching in relation to a top of the thick transparent layer, and
wherein the bottom measurements are obtained while changing the OPD values while maintaining OPD matching in relation to a bottom of the thick transparent layer.

9. The non-transitory computer readable medium according to claim 8, wherein the changing of the OPD values while maintaining OPD matching comprises changing the OPD values by up to tens of nanometers.

10. The non-transitory computer readable medium according to claim 9, wherein a relationship between a measurement of the spectrometer and the OPD values of the measurement comprises a first sinusoidal relationship between the OPD values of the measurement and a first frequency component of the measurement.

11. The non-transitory computer readable medium according to claim 10, wherein the information about the relationship comprises a difference between a maximum value of the first frequency component and a minimal value of the first frequency component.

12. The non-transitory computer readable medium according to claim 11, wherein the determining of the one or more transparent layer reflection parameters comprises determining a field reflectivity of a top or a bottom of the transparent layer.

13. A method for evaluating a thick transparent layer, the method comprising:
generating information about relationships between measurements of a spectrometer of an interferometer and optical path difference (OPD) values of the interferometer; wherein the generating of the information comprises illuminating the thick transparent layer by the interferometer;
determining one or more thick transparent layer reflection parameters, based on the information about the relationship; and
determining one or more structural properties of the thick transparent layer based on the one or more thick transparent layer reflection parameters.

14. The method according to claim 13, wherein the measurements of the spectrometer comprise top measurements and bottom measurements;
wherein the top measurements are obtained while changing the OPD values while maintaining OPD matching in relation to a top of the thick transparent layer, and
wherein the bottom measurements are obtained while changing the OPD values while maintaining OPD matching in relation to a bottom of the thick transparent layer.

15. The method according to claim 14, wherein the changing of the OPD values while maintaining OPD matching comprises changing the OPD values by up to tens of nanometers.

16. The method according to claim 14, wherein a relationship between a measurement of the spectrometer and the OPD values of the measurement comprises a first sinusoidal relationship between the OPD values of the measurement and a first frequency component of the measurement.

17. The method according to claim 16, wherein the information about the relationship comprises a difference between a maximum value of the first frequency component and a minimal value of the first frequency component.

18. The method according to claim 17, wherein the determining of the one or more transparent layer reflection parameters comprises determining a field reflectivity of a top or a bottom of the transparent layer.
